(19) United States
(12) Patent Application Publication
(10) Pub. No.: US 2004/0233196 A1
(43) Pub. Date: Nov. 25, 2004

(54) Logic arrangements storage mediums, and methods for generating digital images using brush strokes

(76) Inventor: Aaron P Hertzmann, Toronto (CA)

Correspondence Address: BAKER & BOTTS, 30 ROCKEFELLER PLAZA, NEW YORK, NY, 10112

(21) Appl. No.: 10/495,271

(22) PCT Filed: Nov. 12, 2002
(86) PCT No.: PCT/US02/36181

Related U.S. Application Data
(60) Provisional application No. 60/350,479, filed on Nov. 13, 2001.

(51) Int. Cl. G06T 11/20

(52) U.S. Cl. 345/441

(57) ABSTRACT

A logic arrangement (120), a storage medium (130), and a method for generating (FIG. 10b) a first digital image (430), are provided. In particular, a second digital image (410) can be generated using one or more brush strokes (200), and the second digital image can be modified based on particular data which is associated with the one or more brush strokes (200) so as to obtain the first digital image (430). Moreover, the first digital image (430) may have a perception of depth. For example, the particular data can include further data associated with a first relative height and a second relative height of the second digital image (410) at a plurality of locations within the second digital image (410). The first relative height of the second digital image (410) at a first location of the plurality of locations may be different than the second relative height of the second digital image (410) at a second location of the plurality of locations. Moreover, the second digital image (410) can be modified based on the particular data so as to obtain the first digital image (430).

### CROSS-REFERENCE TO RELATED APPLICATION

This application claims priority from U.S. Provisional Patent Application No. 60/350,479 entitled “System and Process for Simulating an Appearance of Paint Strokes Under Lighting,” the disclosure of which is incorporated herein by reference in its entirety.

### FIELD OF THE INVENTION

The present invention relates generally to a logic arrangement, storage medium and method for generating a digital image. In particular, the present invention is directed to a logic arrangement, storage medium and method for generating a brush-stroked digital image having a perception of depth.

### BACKGROUND OF THE INVENTION

Conventional software arrangements may be executed by a computer arrangement to generate a brush stroked digital image as described in U.S. Pat. No. 6,011,536. As described in this U.S. patent, when the conventional software arrangement is executed by a computer software arrangement, such arrangement may receive a digital source image and a list of usable brush sizes (e.g., two or more brush sizes). The conventional software arrangement may then be used to fill a canvas image (e.g., the image being worked on) with a predetermined color, and select a brush size (e.g., the largest brush size) from the list of usable brush sizes to be used as a working brush. Then, this software arrangement can digitally blur the source image so as to generate a reference image, e.g., using a non-linear diffusion, a convolution with a Gaussian kernel of standard deviation f_{σ}*Rᵢ, where f_{σ} is a constant factor and Rᵢ is the working brush size, etc. Thereafter, the conventional software arrangement can be used to paint the canvas image based on the reference image with the working brush by using brush strokes. Subsequently, if all of the brush sizes have not been used yet, the conventional software arrangement can configure the processing arrangement to select another brush size (e.g., the next largest brush size), and may also digitally blur the source image so as to generate the reference image. Then, such software arrangement may be used to digitally paint the canvas image based on the reference image with the new working brush by using brush strokes. This process may continue until all of the brush sizes have been used, and preferably, each brush stroke size can capture the details which are at least as large that particular brush stroke.

Some software arrangements can also use fixed texture maps (e.g., arrays of values corresponding to pixel locations) to modulate opacity, color, and/or shape of the final canvas image. Nevertheless, while the brush strokes may appear realistic when viewed individually, when viewed together, the brush strokes may not necessarily appear substantially realistic because the paint does not mix or build up on the surface of the image, and a consistent lighting cannot be applied to the individual brush strokes.

### SUMMARY OF THE INVENTION

Therefore, a need has arisen to provide a logic arrangement, storage medium and method which can generate a digital image which overcome the above-described and other shortcomings of the related art.

One of the advantages of the present invention is that a digital image can be generated so as to have a perception of depth. For example, an initial digital image may be generated using one or more brush strokes, and data indicating the height of the initial digital image at each pixel may also be generated. Further, a final digital image having a perception of depth may then be generated by mapping (e.g., bump mapping) the initial digital image based on the data using a shading model.

These and other advantages can be realized with an exemplary embodiment of the present invention, in which a software arrangement, storage medium and method for generating a first digital image are provided such that the first digital image has a perception of depth. In particular, a second digital image can be generated using one or more brush strokes. For example, this second digital image may be generated using a first brush stroke having a first brush stroke size and a second brush stroke having a second brush size which can be different than the first brush stroke size. Alternatively, the second digital image can be received, e.g., by the computer arrangement that is configured by a logic arrangement or by the storage medium. Further, the second digital image may be modified based on particular data which is associated with the one or more brush strokes so as to obtain the first digital image. The particular data can include further data associated with a first relative height and a second relative height of the second digital image at a plurality of locations (e.g., pixels) within the second digital image. The first relative height of the second digital image at a first location of the plurality of locations may be different than the second relative height of the second digital image at a second location of the plurality of locations. Moreover, the second digital image can be modified based on the particular data which includes the further data so as to obtain the first digital image.

In an exemplary embodiment of the present invention, the further data can include a height field (e.g., a two-dimensional array of data). The height field may indicate the first relative height and the second relative height of the second digital image at the first and second locations, respectively. The height field can be generated by determining a first height map associated with the first brush stroke size and a second height map associated with the second brush stroke size. For example, the first height map can be assigned to the first brush stroke size, and the second height map can be assigned to the second brush stroke size. The first height map may indicate a first height texture in the first brush stroke, and the second height map may indicate a second height texture in the second brush stroke which is different than the first height texture. Moreover, more than one height map can be assigned to each brush stroke size. For example, each particular brush stroke size can be associated with a group of different height maps, and one of the height maps within the group of height maps can be randomly assigned to each brush stroke having the particular brush stroke size.

In another exemplary embodiment of the present invention, the height field can further be generated by determining a first opacity map associated with the first brush stroke size and a second opacity map associated with the second brush stroke size, and/or by determining a first tone associated with the first brush stroke and a second tone associated with the second brush stroke. For example, the first opacity map can be assigned to the first brush stroke size, and the second opacity map can be assigned to the second brush stroke size. Similarly, the first tone can be assigned to the first brush stroke, and the second tone can be assigned to the second brush stroke. The first opacity map may indicate a first transparency of the first brush stroke, and the second opacity map may indicate a second transparency of the second brush stroke which can be different than the first transparency. Moreover, more than one opacity map can be assigned to each brush stroke size. Further, the first tone can indicate a relative darkness of the first brush stroke, and the second tone can indicate a relative darkness of the second brush stroke. Specifically, in order to create the perception of edges or height discontinuities between adjacent brush strokes, each brush stroke used to generate the height field can be assigned a different tone. For example, each of the brush strokes can be ordered and assigned a number n between 0 and N, in which N is the total number of brush strokes to be used to generate the height field, and a constant gray tone can equal to n/N can be added to each brush stroke. Consequently, if the number n assigned to the first brush stroke is greater than the number n assigned to the second brush stroke, the tone or the darkness of the first brush stroke as it appears in the height field may be less than the tone or the darkness of the second brush stroke as it appears in the height field. As such, the first brush stroke may be perceived as having a greater relative height than that of the second brush stroke.

In yet another exemplary embodiment of the present invention, the height field can be generated based on the first height map, second height map, first opacity map, and second opacity map, first tone and/or second tone. For example, the height field can be generated by compositing every brush stroke in a particular order using the height map and the opacity map assigned to each brush stroke, and the tone (e.g., the constant grey tone) can be added to each brush stroke depending on the number n assigned to each brush stroke. Moreover, after the height field is generated, the height field can be blurred, e.g., using a non-linear diffusion, a convolution with a Gaussian kernel of standard deviation f_{σ}*Rᵢ, where f_{σ} is a constant factor and Rᵢ is the working brush size, etc.

In still a further exemplary embodiment of the present invention, the second digital image can be modified based on the particular data to obtain the first digital image. For example, the particular data can include the further data, and the further data can include the height field. Moreover, the first digital image can be generated by mapping (e.g., bump-mapping, displacement-mapping, etc.) the second digital image based on the height field by using a shading model (e.g., a Phong shading model). For example, a first surface normal vector associated with a particular location of the height field, a second surface normal vector associated with a further location of the height field, a lighting at a corresponding particular location of the first digital image and a corresponding further location of the first digital image can be determined using the shading model.

### BRIEF DESCRIPTION OF THE DRAWINGS

FIG. 1 is a schematic diagram of an exemplary embodiment of a system including a software arrangement according to the present invention for generating a final digital image using brush strokes when the software arrangement is executed by a computer or processing arrangement of the system.

FIG. 2 is an exemplary illustration of a brush stroke used by the software arrangement of FIG. 1 and certain data associated therewith.

FIG. 3 is an exemplary illustration of a height map and an opacity map associated with the exemplary brush stroke of FIG. 2.

FIGS. 4a-4c are exemplary illustrations of an initial digital image, a height field, and a final digital image, respectively, generated by the software arrangement of FIG. 1.

FIGS. 5a-5c are exemplary illustrations of various initial digital images generated or received by the software arrangement of FIG. 1.

FIGS. 6a, 6c and 6e are exemplary illustrations which use various exemplary height fields associated with the initial digital image of FIG. 5b generated using the software arrangement of FIG. 1.

FIGS. 6b, 6d and 6f are exemplary illustrations of final digital images which use the corresponding height fields of FIGS. 6a, 6c and 6e generated by the software arrangement of FIG. 1.

FIGS. 7a-7f are exemplary illustrations of final digital images generated by the software arrangement of FIG. 1 using the initial digital image of FIG. 5c and the various height fields associated with the initial digital image as used in the illustrations of FIGS. 6a-6f.

FIG. 8 is a flow diagram of a first exemplary embodiment of a method according to the present invention for generating the final digital image using brush strokes.

FIG. 9 is a flow diagram of a second exemplary embodiment of the method according to the present invention for generating the final digital image using the brush strokes.

FIGS. 10a-10c are flow diagrams of a third exemplary embodiment of the method according to the present invention for generating the final digital image using the brush strokes.

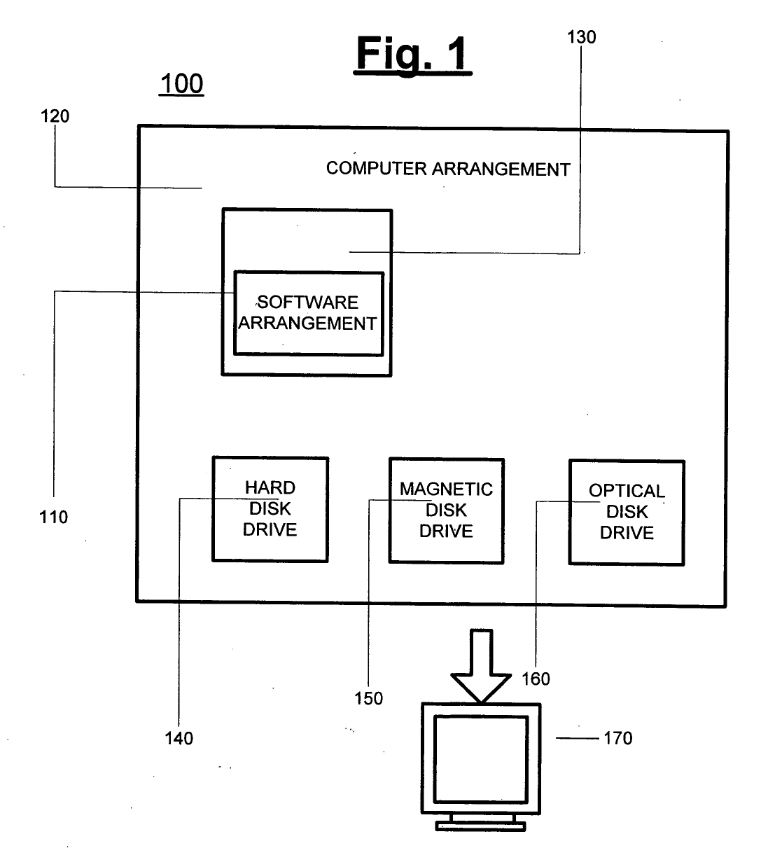

Exemplary embodiments of the present invention and their advantages may be understood by referring to FIGS. 1-10c, like numerals being used for like corresponding parts in the various drawings.

### DETAILED DESCRIPTION

FIG. 1 shows an exemplary embodiment of a system 100 which includes a storage device 130 which provides therein a software arrangement 110, and has a computer arrangement 120 and a processing arrangement (e.g., a microprocessor). This software arrangement 110 is preferably executed by a computer arrangement 120 to generate a digital image. As indicated above, the software arrangement 110 may be resident on the storage device 130 (e.g., a memory device, hard drive, etc.) of the computer arrangement 120, but may also be stored on an external storage device. Instead of using the software arrangement 110, it is possible to utilize a hardware arrangement, a firmware arrangement and/or a combination thereof. The computer arrangement 120 may include a hard disk drive 140 for reading from and/or writing to a hard disk (not shown). The computer arrangement 120 also can include a magnetic disk drive 150 for reading from and/or writing to a removable magnetic disk (not shown). The computer arrangement 120 further can include an optical disk drive 160 for reading from and/or writing to a removable optical disk (not shown), such as a CD ROM or another optical medium. The hard disk, the removable magnetic disk, and the removable optical disk may be examples of storage mediums which can include instructions which may be extracted and executed by the computer arrangement 120. Using such instructions, the computer arrangement 120 can generate a final digital image, and forward such image to a display device 170.

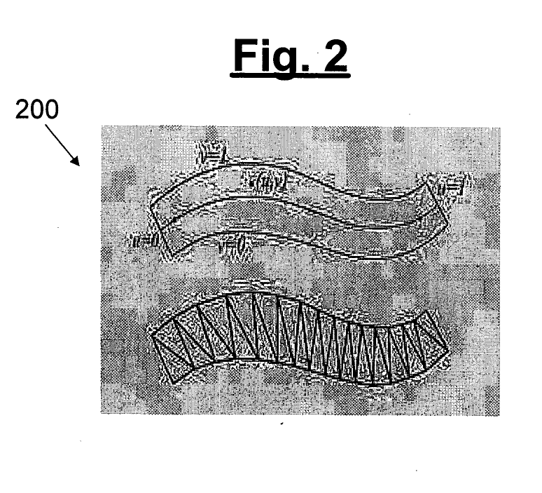

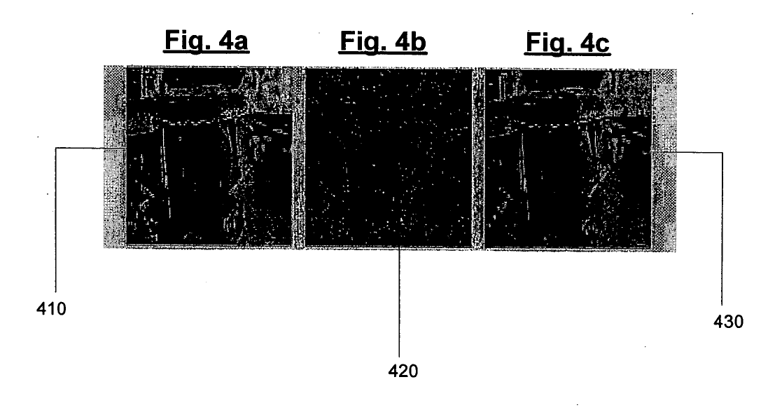

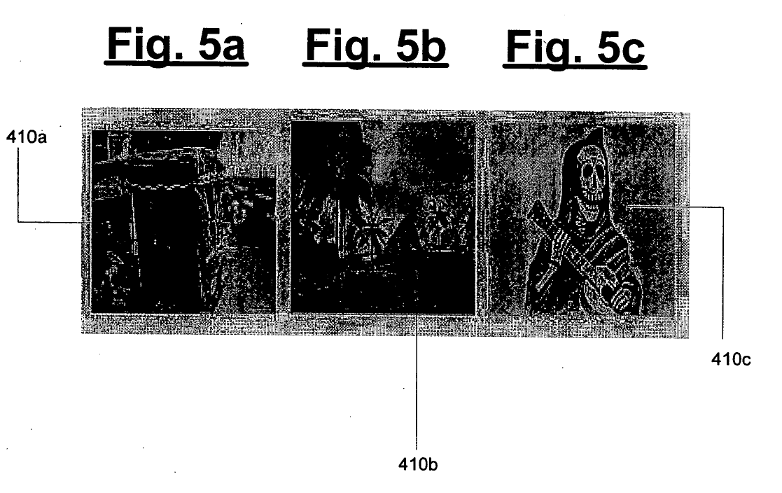

FIGS. 2, 4a, and 5a-5c show exemplary illustrations of certain graphical information which are generated by the computer arrangement 120 when executing the software arrangement 110 so as to produce an initial digital image 410 (FIG. 4a) using one or more brush strokes 200 (FIG. 2). For example, the software arrangement 110 can configure the computer arrangement 120 to generate an initial digital image 410a, 410b, and/or 410c as shown in FIGS. 5a-5c. Nevertheless, it should be understood that the computer arrangement 120 can be configured by the software arrangement 110 to generate an infinite number of different initial digital images 410. Alternatively, the computer arrangement 120 can be configured to receive the initial digital image 410 from an external source (not shown).

In an exemplary embodiment of the present invention, the initial digital image 410 may be generated by the computer arrangement 120 (as configured by the software arrangement 110) in ways similar to those described in the procedures of U.S. Pat. No. 6,011,536, the disclosure of which is incorporated herein by reference in its entirety. For example, the computer arrangement 120 may be configured to receive a digital source image (not shown) and a list of one or more usable brush stroke sizes (e.g., a first brush stroke size and a second brush stroke size used an inputs to an algorithm) associated with one or more brush strokes 200. Each of the brush strokes 200 may be generated by any image processing technique, and using any source, such as 3-D renderer (not shown). Moreover, a shape of such brush strokes 200 may be specified by a smooth curve which can represent the curve's spine. Each brush stroke 200 may have a specified radius (e.g., the screen-space distance from the spine of the brush stroke to an edge of the brush stroke), and a specified color or color texture map. The brush strokes may be tessellated as triangle strips for rendering with graphics hardware, and texture coordinates (Λ,υ) in the brush strokes can be defined such that a particular color or a color texture map may fill the brush stroke 200 without warping.

After receiving the list of brush stroke sizes, the computer arrangement 120 configured by the software arrangement 110 may fill the initial digital image 410 (e.g., the image to be worked on) with a predetermined color, and select a brush size (e.g., the largest brush size) from the list of usable brush sizes to be used as a working brush. Then, the computer arrangement 120 can digitally blur the source image so as to generate a reference image. For example, such digital blurring can be performed using a non-linear diffusion, a convolution with a Gaussian kernel of standard deviation f_{σ}*Rᵢ, where f_{σ} is a constant factor and Rᵢ is the working brush size, etc. Thereafter, the computer arrangement 120 thus configured can execute certain instructions so as to digitally paint the initial digital image 410 based on data associated with the reference image using the working brush by using brush strokes. Subsequently, if all of the brush sizes have not been used yet, the computer arrangement 120 configured in this manner can select another brush size (e.g., the next largest brush size), and may also digitally blur the source image so as to generate the reference image. Then, such computer arrangement 120 can execute additional instructions to digitally paint the initial digital image 410 based on data associated with the reference image with the new working brush by using brush strokes. This procedure may continue until all of the brush sizes have been used, and preferably, with each brush stroke size capturing only details which are at least as large that particular brush stroke. Nevertheless, it should be readily understood by those of ordinary skill in the art that there are numerous ways for generating the initial digital image 410 using one or more of the brush strokes 200, and that the above-described procedure is merely an example of how the computer arrangement 120 can be adapted to generate the initial digital image 410 using one or more of the brush strokes 200. Moreover, in an alternative example, a scanned image can be received by the computer arrangement 120, and the scanned image can be modified using the brush strokes 200 to generate the initial digital image 410.

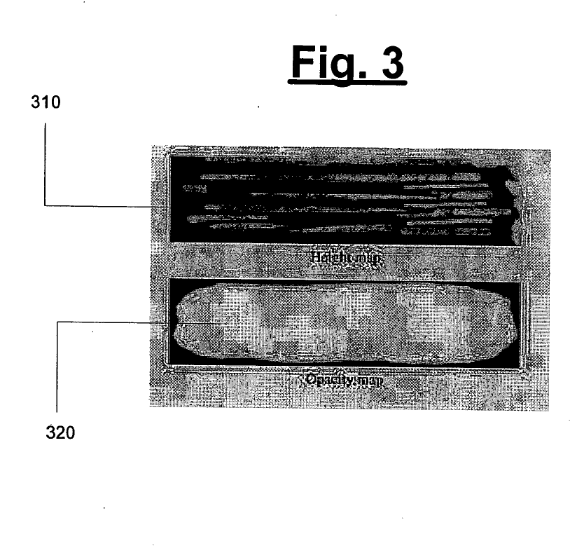

Referring to FIGS. 3, and 4a-4c, as described above, when the software arrangement 110 is executed by the computer arrangement 120, the computer arrangement 120 may be configured to generate or receive the initial digital image 410 (as shown in FIG. 4a). The computer arrangement 120 also can be configured to modify the initial digital image 410 based on particular data which is associated with the one or more brush strokes 200 so as to obtain a final digital image 430 (See FIG. 4c) having a perception of depth. For example, the particular data can include further data associated with first and second relative heights of the initial digital image 410 at a plurality of locations (e.g., pixels) within the initial digital image 410. The first relative height of the initial digital image 410 at a first location of the locations may be different than the second relative height of the initial digital image 410 at a second location of the locations. The first and second locations can be adjacent to one another, or provided at a distance from each other. Moreover, the initial digital image 410 can be modified based on the particular data which includes the further data so as to obtain the final digital image 430.

For example, the further data can include a height field 420, as shown in FIG. 4b. This height field 420 may indicate the first and second relative heights of the initial digital image 410 at the respective first and second locations within the initial digital image 410. The height field 420 can be generated by determining a first height map 310 associated with the first brush stroke size and a second height map associated with the second brush stroke size. The second height map is not shown, but may be similar to the first height map 310. For example, the first height map 310 can be assigned to the first brush stroke size, and the second height map can be assigned to the second brush stroke size. The first height map 310 may indicate a first height texture in the first brush stroke, and the second height map may indicate a second height texture in the second brush stroke. The first and second height textures can be different from one another. Moreover, more than one height map can be assigned to each brush stroke size. For example, each particular brush stroke size can be associated with a group of different height maps, and one of the height maps within such group can be randomly assigned to each brush stroke 200 having the particular brush stroke size.

In another exemplary embodiment of the present invention, the height field 420 can also be generated by determining a first opacity map 320 (see FIG. 3) associated with the first brush stroke size and a second opacity map associated with the second brush stroke size. The second opacity map is not shown but may be similar to the first opacity map 320. In addition or in the alternative, the height field 420 can be generated by determining a first tone associated with the first brush stroke and a second tone associated with the second brush stroke. For example, the first opacity map 320 can be assigned to the first brush stroke size, and the second opacity map can be assigned to the second brush stroke size. Similarly, the first tone can be assigned to the first brush stroke, and the second tone can be assigned to the second brush stroke. The first opacity map 320 may indicate a first transparency of the first brush stroke, and the second opacity map may indicate a second transparency of the second brush stroke. The first and second transparencies can be different from one another. Moreover, more than one opacity map can be assigned to each brush stroke size. Further, the first tone can indicate a relative darkness of the first brush stroke and the second tone can indicate a relative darkness of the second brush stroke.

For example, in order to create the perception of edges or height discontinuities between adjacent brush strokes 200, each brush stroke 200 can be assigned a different tone. As such, each of the brush strokes 200 can be ordered and assigned a number n between 0 and N, in which N is the total number of brush strokes 200 to be used to generate the height field 420, and a constant gray tone equal to n/N can be added to each brush stroke 200. Consequently, if the number n assigned to the first brush stroke is greater than the number n assigned to the second brush stroke, the tone or darkness of the first brush stroke may be smaller than the tone or the darkness of the second brush stroke. Thus, the first brush stroke may be perceived as having a greater relative height than the second brush stroke.

In another exemplary embodiment of the present invention, the height field 420 can be generated based on the first height map 310 and the second height map, the first opacity map 320 and the second opacity map, and/or the first tone and the second tone. For example, the height field 420 can be generated by compositing every brush stroke 200 in a particular order using the height map 310 and the opacity map 320 assigned to each brush stroke 200, and the tone (e.g., the constant grey tone) can be added to each brush stroke 200 depending on the number n assigned to each brush stroke. Various methods of compositing brush strokes 200 are known in the art.

An exemplary method for compositing brush strokes 200 is described in the publication Porter et al., “Compositing Digital Images”, Computer Graphics, Volume 18, Number 3, July 1984, pp. 253-254, the disclosure of which is incorporated by reference herein in its entirety. For example, the first brush stroke can be assigned the number “1,” the second brush stroke can be assigned the number “2,” and a last brush stroke can be assigned the number “N.” Moreover, the computer arrangement 120 may be adapted by the software arrangement 110 to apply the first brush stroke to generate the height field 420 before applying the second brush stroke, which likely follows the first brush stroke. Similarly, the computer arrangement 120 may apply the second brush stroke to generate the height field 420 before applying the last brush stroke. Further, as the number of brush strokes 200 already applied by the computer arrangement 120 increases, the tone of the next applied brush stroke 200 may decrease relative to the tone of the previously-applied brush strokes. Consequently, the last brush stroke may have a perceived relative height which is greater than a perceived relative height of the first brush stroke and/or the second brush stroke. Alternatively, the tone of the next applied brush stroke 200 may increase relative to the tone of the previously-applied brush strokes. Optionally, after the computer arrangement 120 generates the height field 420, this height field 420 can be blurred, e.g., using a non-linear diffusion, a convolution with a Gaussian kernel of standard deviation f_{σ}*Rᵢ, where f_{σ} is a constant factor and Rᵢ is the working brush size, etc.

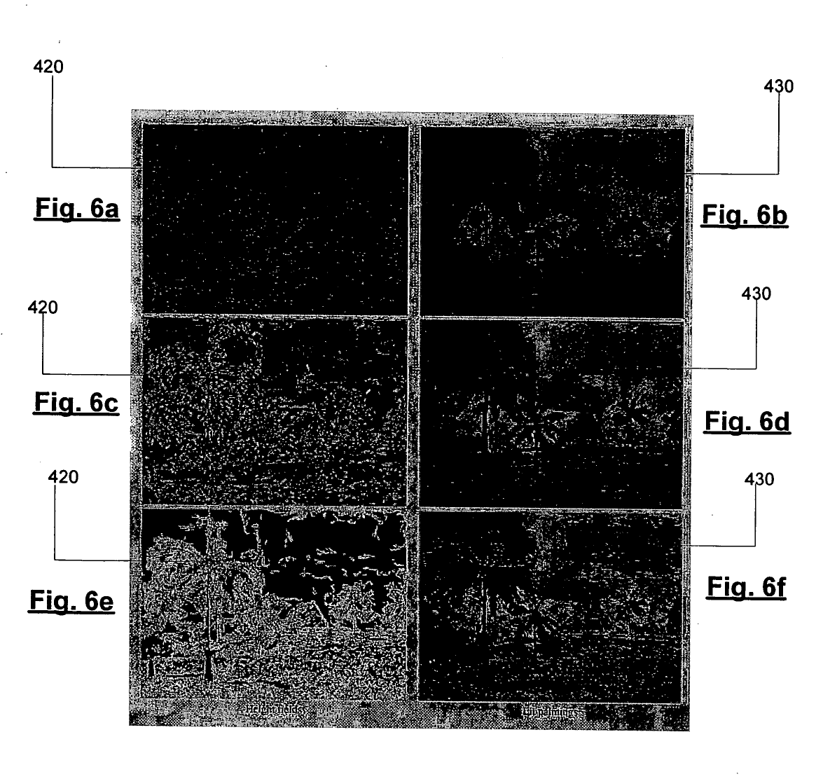

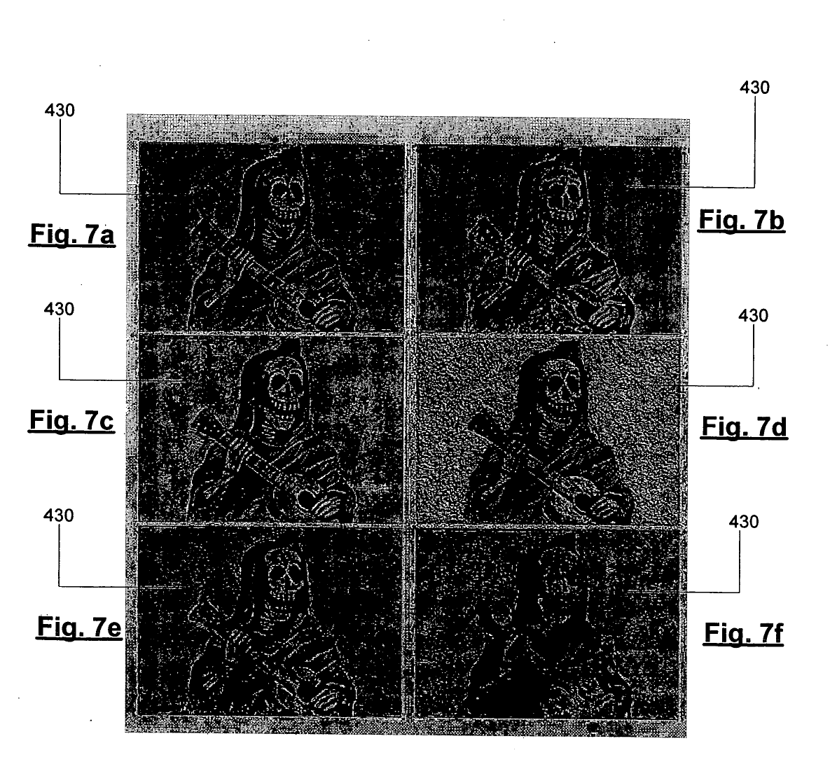

As described above, the computer arrangement 120 can be configured by the software arrangement 110 to modify the initial digital image 410 based on the particular data to obtain the final digital image 430. For example, the particular data can include the further data, and the further data can include the height field 420. Referring to FIGS. 6a-6f and 7a-7f, which shows illustrations generated by an exemplary embodiment of the present invention, the exemplary final digital image 430 shown in FIGS. 6b, 6d and 6f can be generated by mapping (e.g., bump-mapping, displacement-mapping, etc.) the initial digital image 410 based on the particular data such as the height field 420, by using a shading model (e.g., a Phong shading model). It should be understood by those of ordinary skill in the art that there are numerous shading models which may be used to generate the final digital image 430 by mapping the initial digital image 410 based on the particular data. For example, a first surface normal vector associated with a particular location (e.g., pixel) within the height field 420 can be determined in this manner, as wall as a second surface normal vector associated with a further location within the height field 420 can be thus determined. A lighting at a corresponding particular location within the final digital image 430 and a corresponding further location within the final digital image 430 can be determined using the shading model.

In another embodiment of the present invention, the computer arrangement 120 can be adapted to determine the surface normal vector associated with each location within the height field 420 and can ascertain the lighting at each corresponding location within the final digital image 430 using the shading model. For example, in order to determine the surface normal vector associated with each location within the height field 420, it may be advantageous for the computer arrangement 120 to determine the directional derivatives associated with each location within the height field 420. Specifically, it is possible to designate the height field 420 at a location (x,y) as f(x,y). The surface normal can be computed as the cross-product between the vectors (1, 0, f(x+1, y)−f(x−1, y)) and (0, 1, f(x, y+1)−f(x, y−1)), and the vector can be normalized. An exemplary source code implement such procedure of the present invention which can compute the surface normal at each location within the height field 420, e.g., the output to the function is nx, ny, nz, and is provided below.

```
void surfaceNormal(ColorImage * heightField,
int x, int y, float & nx, float & ny, float & nz)
  float dhdx, dhdy;
  if (x ═ 0)
dhdx = heightField−>Pixel(x+1, y) − heightField−>Pixel(x,y);
  else if(x >= heightField−>width()−1)
    dhdx = heightField−>Pixel(x,y) − heightField−>Pixel(x−1,y);
  else
dhdx = heightField−>Pixel(x+1, y) − heightField−>Pixel(x−1,y);
  if (y ═ 0)
dhdy = heightField−>Pixel(x, y+1) − heightField−>Pixel(x,y);
  else if (y >= heightField−>height()−1)
    dhdy = heightField−>Pixel(x,y) − heightField−>Pixel(x,y−1);
  else
dhdy = heightField−>Pixel(x, y+1) − heightField−>Pixel(x,y−1);
  nx = dhdy*heightScale;
  ny = dhdx*heightScale;
  nz = 1;
  float nmag = sqrtf(nx*nx+ny*ny+1);
  nx /= nmag;
  ny /= nmag;
  nz /= nmag;
```

Once the surface normal at each location within the height field is obtained, the lighting at each location within the final digital image 430 can be determined. An exemplary source code which can compute the lighting at each location within the final digital image 430 is also provided below. Moreover, FIGS. 6b, 6d, and 6f depict exemplary final digital images 430a which were generated based on initial digital image 410b and the height fields 420 depicted in FIGS. 6a, 6c, and 6e, respectively, using such source code. Similarly, FIGS. 7a-7f depict exemplary final digital images 430b which were generated based on initial digital image 410c and varying height fields 420, utilizing such exemplary source code as provided below.

void emboss(ColorImage * sourceImage, ColorImage * heightField,
ColorImage * embossedPtg, int x, int y)
{
// compute surface normal
float nx, ny, nz;
surfaceNormal(heightField, x,y, nx, ny, nz);

| | |
|---|---|
| float fx = x/embossedPtg−>width( ); | // x position, scaled to be from 0 to 1 |
| float fy = y/embossedPtg−>height( ); | // y position, scaled to be from 0 to 1 |

```
// compute the vector from the light to a point (a.k.a. the light vector)
float lightvecx = lightx − fx, lightvecy = lighty − fy,
    lightvecz = lightz;
// normalize the light vector
float lightmag = sqrt(lightvecx*lightvecx + lightvecy*lightvecy +
        lightvecz*lightvecz);
lightvecx /= lightmag;
lightvecy /= lightmag;
lightvecz /= lightmag;
// compute the reflection vector (light reflection if the surface was perfect mirror)
float rx = 2*nx − lightvecx;
float ry = 2*ny − lightvecy;
float rz = 2*nz − lightvecz;
// normalize the reflection vector
float rmag = sqrt(rx*rx + ry*ry + rz*rz);
rx /= rmag;
ry /= rmag;
rz /= rmag;
// compute the diffuse lighting term
float diffuseFac = lightvecx*nx + lightvecy*ny + lightvecz*nz;
if (diffuseFac < 0) diffuseFac =0;
diffuseFac = diffuse*pow(diffuseFac,diffuseSpread);
// compute the highlight (specular) term.
float highlightFac = highlight*pow(rz,highlightSpread);
// sum all the terms for all three color channels
for(int d=0;d<3;d++)
  {
    // get the painting color
    float = val sourceImage−>Pixel(x,y,d);
    // apply the Phong lighting equation to that color
    val = (ambient + diffuseFac) * val +
      highlightFac*sourceImage−>maxVal( );
    // clamp the color so that it doesn't go over 255
    if (val > sourceImage−>maxVal( ))
      val = sourceImage−>maxVal( );
    // save the color of the lit painting
    embossedPtg−>Pixel(x,y,d) = (unsigned char)val;
```

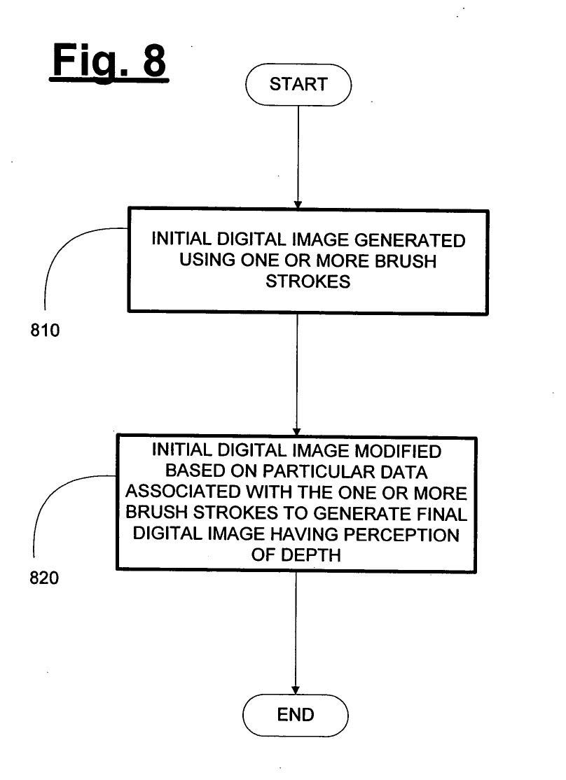

FIG. 8 shows a flow diagram of a first exemplary embodiment of a method according to the present invention for generating the exemplary final digital image 430. In step 810, the initial digital image 410 is generated using the one or more of the brush strokes 200. Moreover, in step 820, the exemplary final digital image 430 having the perception of depth is generated by modifying the initial digital image 410 based on the particular data which is associated with the one or more of these brush strokes 200.

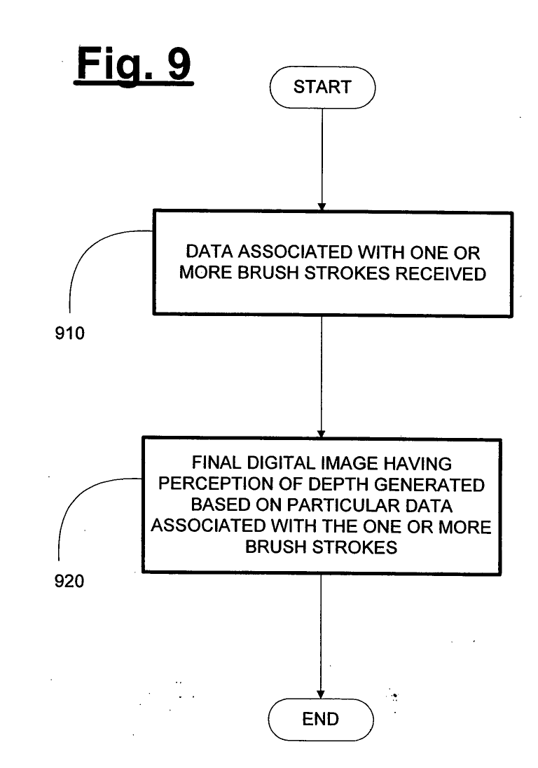

FIG. 9 shows a flow diagram of a second exemplary embodiment of the method according to the present invention for generating the exemplary final digital image 430. Particularly, in step 910, data associated with the one or more of the brush strokes 200 can be received. Then, in step 920, the exemplary final digital image 430 having the perception of depth is generated based on the particular data which is associated with the one or more of such brush strokes 200.

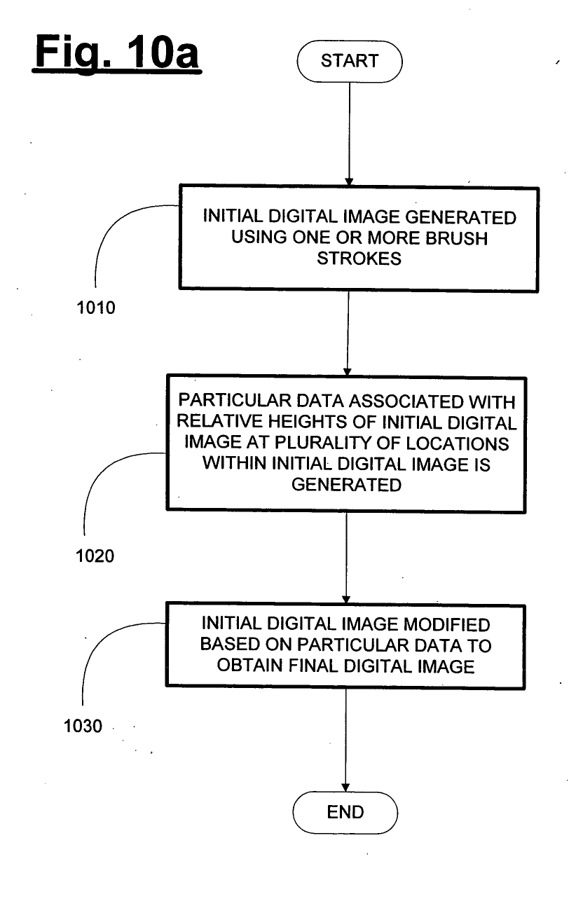

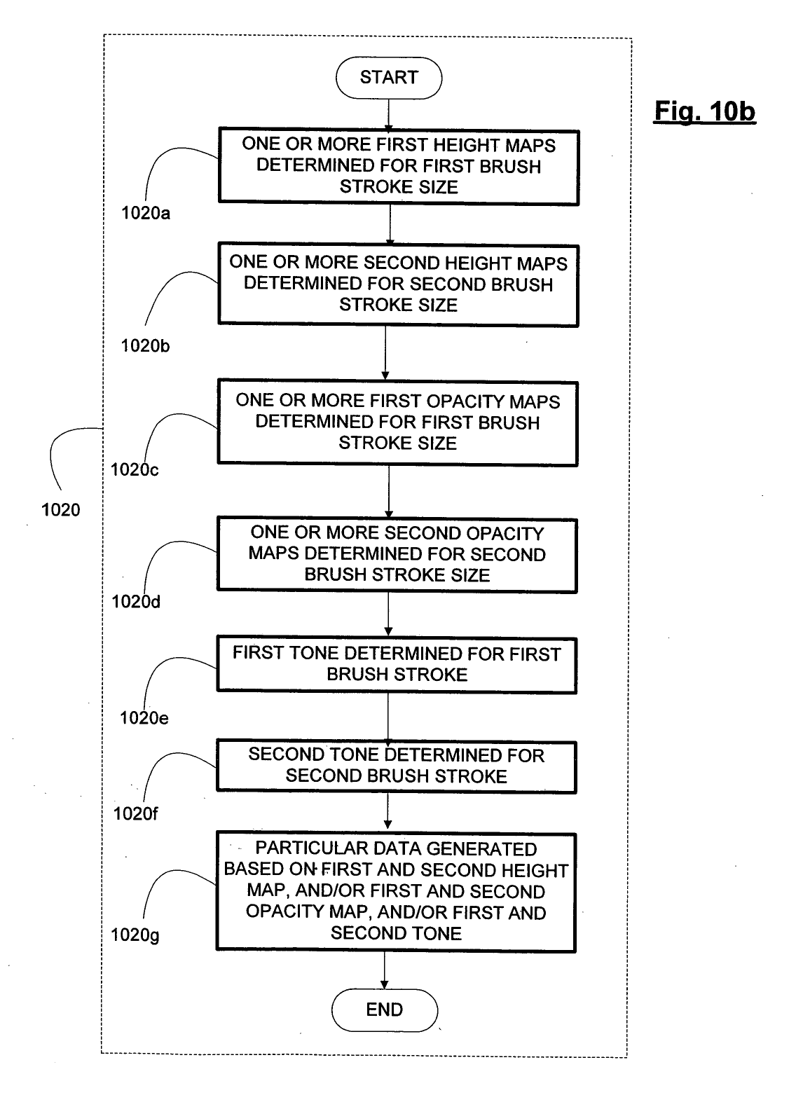

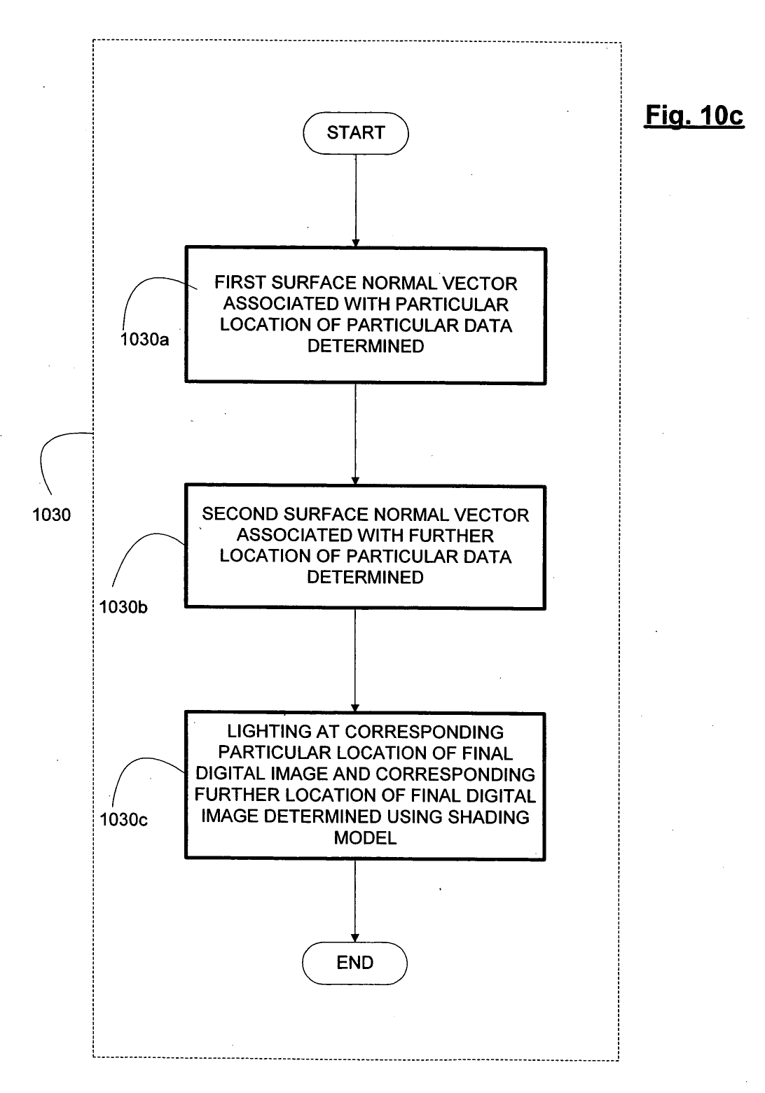

FIG. 10a shows a flow diagram of a third exemplary embodiment of the method according to the present invention for generating the exemplary final digital image 430. In step 1010, the initial digital image 410 is generated using the one or more of the brush strokes 200. In step 1020, the particular data associated with a first relative height and a second relative height of the initial digital image 410 at a plurality of locations within the initial digital image 410 can be generated. For example, the first relative height of the initial digital image 410 at a first location of the plurality of locations is different than the second relative height of the initial digital image 410 at a second location of the plurality of locations.

As shown in FIG. 10b, step 1020 can include steps 1020a-1020g. In step 1020a, a first of the brush strokes 200 can have a first brush stroke size, and one or more first height maps can be determined for the first brush stroke size. Similarly, in step 1020b, a second of the brush strokes 200 can have a second brush stroke size which is different than the first brush stroke size, and one or more second height maps can be determined for the second brush stroke size. In step 1020c, one or more first opacity maps can be determined for the first brush stroke size, and in step 1020d, one or more second opacity maps can be determined for the second brush stroke size. Further, in step 1020e, a first tone associated with the first of brush strokes 200 can be determined, and in step 1020f, Moreover, in step 1030, a second tone associated with the second of brush strokes 200 which is different than the first tone can be determined. Finally, in step 1020g, the particular data can be generated based on the first height map and the second height map, and/of the first opacity map and the second opacity map, and/or the first tone and the second tone. For example, the particular data can include the height field 420. Moreover, in step 1030 of FIG. 10a, the exemplary final digital image 430 is generated by modifying (e.g., mapping) the initial digital image 410 based on the particular data.

For example, referring to FIG. 10c, step 1030 can include steps 1030a-1030c. In step 1030a, a first normal vector associated with a particular location of the particular data (e.g., a particular location of the height field 420) can be determined. In step 1030b, a second normal vector associated with a further location of the particular data (e.g., a further location of the height field 420) can be determined. Moreover, in step 1030c, a lighting at a corresponding particular location of the final digital image and a corresponding further location of the final digital image is determined using a shading model. It should be understood that other methods can be implemented to generate the exemplary final digital image 430 that utilize the concepts described herein above.

While the invention has been described in connecting with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It is intended that the specification and the described examples are considered as exemplary only, with the true scope and spirit of the invention indicated by the following claims.

What is claimed is:

1. A method for generating a first digital image, comprising the steps of:
generating a second digital image using at least one brush stroke; and
modifying the second digital image based on particular data associated with the at least one brush stroke so as to obtain the first digital image, wherein the first digital image has a perception of depth.

2. The method of claim 1, further comprising the step of generating further data associated with a first relative height and a second relative height of the second digital image at a plurality of locations within the second digital image, wherein the first relative height of the second digital image at a first location of the locations is different than the second relative height of the second digital image at a second location of the locations, and wherein the particular data comprises the further data.

3. The method of claim 2, wherein the at least one brush stroke includes a plurality of brush strokes, wherein a first brush stroke of the plurality of brush strokes has a first brush stroke size, wherein a second brush stroke of the plurality of brush strokes has a second brush stroke size which is different than the first brush stroke size, and wherein the step of generating the further data comprises the steps of:
determining at least one first height map associated with the first brush stroke size; and
determining at least one second height map associated with the second brush stroke size.

4. The method of claim 3, wherein the at least one first height map is different than the at least one second height map, and wherein the further data is a generated based on the first height map and the second height map.

5. The method of claim 3, wherein the step of generating the further data further comprises the steps of:
determining at least one first opacity map associated with the first brush stroke size; and
determining at least one second opacity map associated with the second brush stroke size.

6. The method of claim 5, wherein the at least one first opacity map is different than the at least one second opacity map, wherein the at least one first height map is different than the at least one second height map, and wherein the further data is a generated based on the first height map, the second height map the first opacity map and the second opacity map.

7. The method of claim 3, wherein the step of generating the further data further comprises the steps of:
determining a first tone associated with the first brush stroke; and
determining a second tone associated with the second brush stroke, wherein the first tone is different than the second tone, such that the difference between the first tone and the second tone provides a perception that an edge is formed between the first brush stroke and the second brush stroke.

8. The method of claim 7, wherein the further data is generated based on the first height map, the second height map, the first tone and the second tone.

9. The method of claim 7, wherein the step of generating the further data further comprises the steps of:
determining at least one first opacity map associated with the first brush stroke size; and
determining at least one second opacity map associated with the second brush stroke size, wherein the at least one first opacity map is different than the at least one second opacity map.

10. The method of claim 9, wherein the further data is generated based on the first height map, the second height map, the first tone, the second tone, the first opacity map and the second opacity map.

11. The method of claim 2, wherein the modifying step comprises the step of mapping the second digital image based on the further data.

12. The method of claim 11, wherein the mapping step comprises the step of bump-mapping the second digital image based on the further data.

13. The method of claim 12, wherein the bump-mapping step comprises the steps of:
determining a first surface normal vector associated with a particular location of the further data;
determining a second surface normal vector associated with a further location of the further data; and
determining a lighting at a corresponding first location of the first digital image and a corresponding second location of the first digital image using a shading model.

14. The method of claim 13, wherein the shading model is a Phong shading model.

15. The method of claim 2, wherein the mapping step comprises the step of displacement-mapping the second digital image based on the further data.

16. A method for generating a particular image, comprising the steps of:
receiving data associated with at least one brush stroke; and
generating the particular image based on particular data associated with the at least one brush stroke, wherein the particular image has a perception of depth.

17. The method of claim 16, further comprising the step of generating a further image using the at least one brush stroke.

18. The method of claim 17, further comprising the step of generating further data associated with a first relative height and a second relative height of the further digital image at a plurality of locations within the further digital image, wherein the first relative height of the further digital image at a first location of the plurality of locations is different than the second relative height of the further digital image at a second location of the plurality of locations, and wherein the particular data comprises the further data.

19. The method of claim 18, wherein the at least one brush stroke includes a plurality of brush strokes, wherein a first brush stroke of the plurality of brush strokes has a first brush stroke size and a second brush stroke of the plurality of brush strokes has a second brush stroke size which is different than the first brush stroke size, and wherein the step of generating the further data comprises the steps of:
determining at least one first height map associated with the first brush stroke size; and
determining at least one second height map associated with the second brush stroke size, wherein the at least one first height map is different than the at least one second height map.

20. The method of claim 18, wherein the step of generating the particular image comprises the step of modifying the further image based on the further data.

21. A method for generating a first digital image, comprising the steps of:
generating a second digital image using at least one brush stroke;
generating particular data associated with a first relative height and a second relative height of the second digital image at a plurality of locations within the second digital image, wherein the first relative height of the second digital image at a first location of the locations is different than the second relative height of the second digital image at a second location of the locations; and
modifying the second digital image based on the particular data so as to obtain the first digital image.

22. The method of claim 21, wherein the at least one brush stroke includes a plurality of brush strokes, wherein a first brush stroke of the plurality of brush strokes has a first brush stroke size, wherein a second brush stroke of the plurality of brush strokes has a second brush stroke size which is different than the first brush stroke size, and wherein the step of generating the particular data comprises the steps of:
determining at least one first height map associated with the first brush stroke size; and
determining at least one second height map associated with the second brush stroke size.

23. The method of claim 22, wherein the at least one first height map is different than the at least one second height map, and wherein the particular data is a generated based on the first height map and the second height map.

24. The method of claim 22, wherein the step of generating the particular data further comprises the steps of:
determining at least one first opacity map associated with the first brush stroke size; and
determining at least one second opacity map associated with the second brush stroke size.

25. The method of claim 24, wherein the at least one first height map is different than the at least one second height map, wherein the at least one first opacity map is different than the at least one second opacity map, and wherein the particular data is a generated based on the first height map, the second height map, the first opacity map and the second opacity map.

26. The method of claim 22, wherein the step of generating the particular data further comprises the steps of:
determining a first tone associated with the first brush stroke; and
determining a second tone associated with the second brush stroke, wherein the first tone is different than the second tone, such that the difference between the first tone and the second tone provides a perception that an edge is formed between the first brush stroke and the second brush stroke.

27. The method of claim 26, wherein the particular data is generated based on the first height map, the second height map, the first tone and the second tone.

28. The method of claim 26, wherein the step of generating the particular data further comprises the steps of:
determining at least one first opacity map associated with the first brush stroke size; and
determining at least one second opacity map associated with the second brush stroke size, wherein the at least one first opacity map is different than the at least one second opacity map.

29. The method of claim 28, wherein the particular data is generated based on the first height map, the second height map, the first tone, the second tone, the first opacity map and the second opacity map.

30. The method of claim 21, wherein the modifying step comprises the step of mapping the second digital image based on the particular data.

31. The method of claim 30, wherein the mapping step comprises the step of bump-mapping the second digital image based on the particular data.

32. The method of claim 31, wherein the bump-mapping step comprises the steps of:
determining a first surface normal vector associated with a particular location of the particular data;
determining a second surface normal vector associated with a further location of the particular data; and
determining a lighting at a corresponding first location of the first digital image and a corresponding second location of the first digital image using a shading model.

33. The method of claim 32, wherein the shading model is a Phong shading model.

34. The method of claim 21, wherein the mapping step comprises the step of displacement-mapping the second digital image based on the particular data.

35. A logic arrangement for generating a first digital image, which, when being executed by a processing arrangement, configures the processing arrangement to perform the steps comprising of:
generating a second digital image using at least one stroke; and
modifying the second digital image based on particular data associated with the at least one brush stroke so as to obtain the first digital image, wherein the first digital image has a perception of depth.

36. The logic arrangement of claim 35, wherein, when executing the logic arrangement, the processing arrangement is further configured to generate further data which is associated with a relative first height and a relative second height of the second digital image at a plurality of locations within the second digital image, wherein the first relative height of the second digital image at a first location of the plurality of locations is different than the second relative height of the second digital image at a second location of the plurality of locations, and wherein the particular data comprises the further data.

37. The logic arrangement of claim 36, wherein the at least one brush stroke includes a plurality of brush strokes, wherein a first brush stroke of the plurality of brush strokes has a first brush stroke size and a second brush stroke of the plurality of brush strokes has a second brush stroke size which is different than the first brush stroke size, and wherein, when executing the logic arrangement, the processing arrangement is further configured to perform the steps of:
determining at least one first height map associated with the first brush stroke size; and
determining at least one second height map associated with the second brush stroke size.

38. The logic arrangement of claim 37, wherein the at least one first height map is different than the at least one second height map, and wherein the processing arrangement is configured by the logic arrangement to generate the further data based on the first height map and the second height map.

39. The logic arrangement of claim 37, wherein the processing arrangement is configured by the logic arrangement to perform the steps of:
determining at least one first opacity map associated with the first brush stroke size; and
determining at least one second opacity map associated with the second brush stroke size.

40. The logic arrangement of claim 39, wherein the at least one first height map is different than the at least one second height map, wherein the at least one first opacity map is different than the at least one second opacity map, and wherein the processing arrangement is configured by the logic arrangement to generate the further data based on the first height map, the second height map, the first opacity map and the second opacity map.

41. The logic arrangement of claim 37, wherein the processing arrangement is configured by the logic arrangement to perform the steps of:
determining a first tone associated with the first brush stroke; and
determining a second tone associated with the second brush stroke, wherein the first tone is different than the second tone, such that the difference between the first tone and the second tone provides a perception that an edge is formed between the first brush stroke and the second brush stroke.

42. The logic arrangement of claim 41, wherein the processing arrangement is configured by the logic arrangement to generate the further data based on the first height map, the second height map, the first tone and the second tone.

43. The logic arrangement of claim 41, wherein the processing arrangement is configured by the logic arrangement to perform the steps of:
determining at least one first opacity map associated with the first brush stroke size; and
determining at least one second opacity map associated with the second brush stroke size, wherein the at least one first opacity map is different than the at least one second opacity map.

44. The logic arrangement of claim 43, wherein the processing arrangement is configured by the logic arrangement to generate the further data based on the first height map, the second height map, the first tone, the second tone, the first opacity map and the second opacity map.

45. The logic arrangement of claim 36, wherein the processing arrangement is configured by the logic arrangement to modify the second digital image by mapping the second digital image based on the further data.

46. The logic arrangement of claim 45, wherein the processing arrangement is configured by the logic arrangement to map the second digital image by bump-mapping the second digital image based on the further data.

47. The logic arrangement of claim 46, wherein the processing arrangement is configured by the logic arrangement to bump-map the second digital image by:
determining a first surface normal vector associated with a particular location of the further data;
determining a second surface normal vector associated with a further location of the further data; and
determining a lighting at a corresponding first location of the first digital image and a corresponding second location of the first digital image using a shading model.

48. The logic arrangement of claim 47, wherein the shading model is a Phong shading model.

49. The logic arrangement of claim 36, wherein the processing arrangement is operable to map the second digital image by displacement-mapping the second digital image based on the further data.

50. A logic arrangement for generating a particular image, which, when being executed by a processing arrangement, configures the processing arrangement to perform the steps comprising of:
receiving data associated with at least one brush stroke; and
generating the particular image based on particular data associated with the at least one brush stroke, wherein the particular image has a perception of depth.

51. The logic arrangement of claim 50, wherein the processing arrangement is further configured by the logic arrangement to generate a further image using the at least one brush stroke.

52. The logic arrangement of claim 51, wherein the processing arrangement is further configured to generate further data which is associated with a first relative height and a second relative height of the further digital image at a plurality of locations within the further digital image, wherein the first relative height of the further digital image at a first location of the locations is different than the second relative height of the further digital image at a second location of the locations, and wherein the particular data comprises the further data.

53. The logic arrangement of claim 52, wherein the at least one brush stroke includes a plurality of brush strokes, wherein a first brush stroke of the plurality of brush strokes has a first brush stroke size and a second brush stroke of the plurality of brush strokes has a second brush stroke size which is different than the first brush stroke size, and wherein the processing arrangement is further configured by the logic arrangement to perform the steps of:
determining at least one first height map associated with the first brush stroke size; and
determining at least one second height map associated with the second brush stroke size, wherein the at least one first height map is different than the at least one second height map.

54. The logic arrangement of claim 52, wherein the processing arrangement is further configured by the logic arrangement to generate the particular image by modifying the further image based on the further data.

55. A logic arrangement for generating a first digital image, which, when being executed by a processing arrangement, configures the processing arrangement to perform the steps comprising of:
generating a second digital image using at least one brush stroke;
generating particular data associated with a first relative height and a second relative height of the second digital image at a plurality of locations within the second digital image, wherein the first relative height of the second digital image at a first location of the locations is different than the second relative height of the second digital image at a second location of the locations; and
modify the second digital image based on the particular data so as to obtain the first digital image.

56. The logic arrangement of claim 55, wherein the at least one brush stroke includes a plurality of brush strokes, wherein a first brush stroke of the plurality of brush strokes has a first brush stroke size and a second brush stroke of the plurality of brush strokes has a second brush stroke size which is different than the first brush stroke size, and wherein the processing arrangement is further configured by the logic arrangement to perform the steps of:
determining at least one first height map associated with the first brush stroke size; and
determining at least one second height map associated with the second brush stroke size.

57. The logic arrangement of claim 56, wherein the at least one first height map is different than the at least one second height map, and wherein the processing arrangement is configured by the logic arrangement to generate the particular data based on the first height map and the second height map.

58. The logic arrangement of claim 56, wherein the processing arrangement is further configured by the logic arrangement to perform the steps of:
determining at least one first opacity map associated with the first brush stroke size; and
determining at least one second opacity map associated with the second brush stroke size.

59. The logic arrangement of claim 58, wherein the at least one first height map is different than the at least one second height map, wherein the at least one first opacity map is different than the at least one second opacity map, and wherein the processing arrangement is configured by the logic arrangement to generate the particular data based on the first height map, the second height map, the first opacity map and the second opacity map.

60. The logic arrangement of claim 56, wherein the processing arrangement is further configured by the logic arrangement to perform the steps of:
determining a first tone associated with the first brush stroke; and
determining a second tone associated with the second brush stroke, wherein the first tone is different than the second tone, such that the difference between the first tone and the second tone creates a perception that an edge is formed between the first brush stroke and the second brush stroke.

61. The logic arrangement of claim 60, wherein the processing arrangement is configured by the logic arrangement to generate the particular data based on the first height map, the second height map, the first tone and the second tone.

62. The logic arrangement of claim 60, wherein the processing arrangement is further configured by the logic arrangement to perform the steps of:
determining at least one first opacity map associated with the first brush stroke size; and
determining at least one second opacity map associated with the second brush stroke size, wherein the at least one first opacity map is different than the at least one second opacity map.

63. The logic arrangement of claim 62, wherein the processing arrangement is configured by the logic arrangement to generate the particular data based on the first height map, the second height map, the first tone, the second tone, the first opacity map and the second opacity map.

64. The logic arrangement of claim 55, wherein the processing arrangement is configured by the logic arrangement to modify the second digital image by mapping the second digital image based on the further data.

65. The logic arrangement of claim 64, wherein the processing arrangement is configured by the logic arrangement to map the second digital image by bump-mapping the second digital image based on the further data.

66. The logic arrangement of claim 65, wherein the processing arrangement is configured by the logic arrangement to bump-map the second digital image by:
determining a first surface normal vector associated with a particular location of the further data;
determining a second surface normal vector associated with a further location of the further data; and
determining a lighting at a corresponding particular location of the first digital image and a corresponding further location of the first digital image using a shading model.

67. The logic arrangement of claim 66, wherein the shading model is a Phong shading model.

68. The logic arrangement of claim 55, wherein the processing arrangement is configured by the logic arrangement to map the second digital image by displacement-mapping the second digital image based on the further data.

69. A storage medium including executable instruction for generating a first digital image, wherein, when the executable instructions are performed by a processing arrangement the executable instructions performing the steps comprising of:
generating a second digital image using at least one brush stroke; and
modifying the second digital image based on particular data associated with the at least one brush stroke so as to obtain the first digital image, wherein the first digital image has a perception of depth.

70. The storage medium of claim 69, wherein the computer executable instructions are further adapted to generate further data which is associated with a first relative height and a second relative height of the second digital image at a plurality of locations within the second digital image, wherein the first relative height of the second digital image at a first location of the locations is different than the second relative height of the second digital image at a second location of the locations, and wherein the particular data comprises the further data.

71. The storage medium of claim 70, wherein the at least one brush stroke include a plurality of brush strokes, wherein a first brush stroke of the plurality of brush strokes has a first brush stroke size and a second brush stroke of the plurality of brush strokes has a second brush stroke size which is different than the first brush stroke size, and wherein the further data is generated by:
determining at least one first height map associated with the first brush stroke size; and
determining at least one second height map associated with the second brush stroke size, wherein the at least one first height map is different than the at least one second height map.

72. The storage medium of claim 70, wherein the second digital image is modified by mapping the second digital image based on the further data.

73. A storage medium including executable instruction for generating a first digital image, wherein, when the executable instructions are executed on a processing arrangement, the executable instructions performing the steps comprising of:
receiving data associated with at least one brush stroke; and
generating the particular image based on particular data associated with the at least one brush stroke, wherein the particular image has a perception of depth.

74. The storage medium of claim 73, wherein the executable instructions are operable to further perform the step of generating a further image using the at least one brush stroke.

75. The storage medium of claim 74, wherein the computer executable instructions are operable to further perform the step of generating further data which is associated with a first relative height and a second relative height of the further digital image at a plurality of locations within the further digital image, wherein the first relative height of the further digital image at a first location of the locations is different than the second relative height of the further digital image at a second location of the locations, and wherein the particular data comprises the further data.

76. The storage medium of claim 75, wherein the at least one brush stroke includes a plurality of brush strokes, wherein a first brush stroke of the plurality of brush strokes has a first brush stroke size and a second brush stroke of the plurality of brush strokes has a second brush stroke size which is different than the first brush stroke size, and wherein the executable instruction of generating the further data comprises:
determining at least one first height map associated with the first brush stroke size; and
determining at least one second height map associated with the second brush stroke size, wherein the at least one first height map is different than the at least one second height map.

77. The storage medium of claim 76, wherein the executable instruction of generating the particular image comprises the step of modifying the further image based on the further data.

78. A storage medium including executable instruction for generating a first digital image, wherein, when the executable instructions are executed by a processing arrangement, the executable instructions performing the steps comprising of:
generating a second digital image using at least one brush stroke;
generating particular data associated with a first relative height and a second relative height of the second digital image at a plurality of locations within the second digital image, wherein the first relative height of the second digital image at a first location of the plurality of locations is different than the second relative height of the second digital image at a second location of the plurality of locations; and
modifying the second digital image based on the particular data so as to obtain the first digital image.

79. The storage medium of claim 78, wherein the at least one brush stroke includes a plurality of brush strokes, wherein a first brush stroke of the plurality of brush strokes has a first brush stroke size and a second brush stroke of the plurality of brush strokes has a second brush stroke size which is different than the first brush stroke size, and wherein the step of generating the particular data comprises the steps of:
determining at least one first height map associated with the first brush stroke size; and
determining at least one second height map associated with the second brush stroke size, wherein the at least one first height map is different than the at least one second height map.

80. The storage medium of claim 78, wherein the second digital image is modified by mapping the second digital image based on the particular data.
